(19) United States
(12) Patent Application Publication
(10) Pub. No.: US 2026/0147368 A1
(43) Pub. Date: May 28, 2026

(54) HYBRID VOLTAGE REFERENCE CIRCUIT WITH THRESHOLD VOLTAGE VARIATION COMPENSATION

(71) Applicant: IMEC VZW, Leuven (BE)

(72) Inventors: Chutham Sawigun, Leuven (BE); Xiaolin Yang, Leuven (BE); Carolina Mora Lopez, Heverlee (BE)

(21) Appl. No.: 19/400,398

(22) Filed: Nov. 25, 2025

(30) Foreign Application Priority Data
Nov. 27, 2024 (EP) 24215625.5

(51) Int. Cl. G05F 3/08

(52) U.S. Cl. CPC G05F 3/08

(57) ABSTRACT

A reference voltage circuit is provided and may be used with a temperature sensor of a neural interface. The circuit includes a first MOS transistor providing a current to a set of transistors, including a second MOS transistor generating a first PTAT voltage, a BJT generating a CTAT voltage, and a third MOS transistor generating a second PTAT voltage. The reference voltage is the sum of the first and second PTAT voltage and the CTAT voltage. The first and the third MOS transistors are of the same type, and a source-bulk voltage of the third MOS transistor is non-zero. The first PTAT voltage is independent of a threshold voltage of the second MOS transistor, and a dependence of the second PTAT voltage on the threshold voltage of the third MOS transistor is opposite of a dependence of the CTAT voltage on a threshold voltage of the first MOS transistor.

### CROSS-REFERENCE TO RELATED APPLICATIONS

The present application is a non-provisional patent application claiming priority to European Patent Application No. 24215625.5, filed Nov. 27, 2024, the contents of which are hereby incorporated by reference.

### FIELD OF THE DISCLOSURE

The present disclosure relates to voltage reference (VR) circuits for providing a reference voltage. For example, such circuits may provide a reference voltage to hybrid VR circuits including metal oxide semiconductor (MOS) transistors and a bipolar junction transistor (BJT). The present disclosure provides a hybrid VR circuit configured to cancel out variations of the reference voltage caused by fabrication-process skew, threshold voltage variation, and transistor mismatch.

### BACKGROUND

A VR circuit is a useful part of a power management unit (PMU), as it provides a reliable reference voltage to further produce DC voltages, in order to bias or supply an electronic circuit. The output voltage of a VR circuit shall be able to tolerate temperature, supply voltage, and fabrication process variations.

Bandgap voltage reference (BGR) is an example of a VR approach, which has been widely used. A BGR circuit is built from bipolar transistors, resistors, and an operational amplifier. It also uses a start-up circuit. Therefore, it consumes and occupies a considerable amount of power and chip area. Traditional BGR circuits are thus not suitable for some of today's applications, if the power requirement is stringent, e.g., for biomedical devices and environmental sensors for Internet of Things (IoT) applications.

To achieve a VR circuit in a compact architecture, which consumes less power (e.g., a pico-watt level of power), various complementary MOS (CMOS) VR circuits have been proposed. However, since CMOS VR circuits are typically based on a difference in threshold voltages of two different MOS devices, they suffer from threshold voltage variations. Compensation for this variation commands complicated procedures.

In summary, improved approaches for designing and fabrication of VR circuits may be useful.

### SUMMARY

The present disclosure provides improvements based at least in part on the following considerations.

A hybrid VR circuit may be composed of a single BJT and a few MOS transistors, and may provide a compact architecture and pico-watt power consumption. The hybrid VR circuit may be based on the same principle as a BGR circuit, and should be reliable. However, such a VR circuit may suffer from threshold voltage variations of its MOS transistors, but from (e.g., only) one type of MOS transistors. The threshold voltage variations of the hybrid VR circuit may thus be easier to compensate when compared with the CMOS VR circuit.

FIG. 5A shows an example hybrid VR circuit. It combines a proportional to absolute temperature (PTAT) voltage and a complementary to absolute temperature (CTAT) voltage in a stacking manner. For this, the circuit uses (e.g., requires) three MOS transistors, labelled M_{CS} and M_{D} (twice), which (e.g., all) should have a small channel width W (e.g., in the order of W<1.2 μm). This facilitates obtaining different process skews of the threshold voltages, so that their variations may cancel each other out. The additional MOS transistor M_{RG} may be larger in size, since it is a regulated transistor that does not contribute to process variation.

When transistor mismatch is concerned, the hybrid VR circuit of FIG. 5A cannot provide a reliable output reference voltage, since matching three small transistor devices may not be made specifically (e.g., precisely). Therefore, the programmability of each MOS transistor (trimming) may be arranged on-chip, and this may include (e.g., require) multiple units of the respective MOS transistors M_{CS} and M_{D}, as shown in FIG. 5B. This compensation architecture may make the hybrid VR circuit no longer compact and practical for general use.

This disclosure is directed to addressing and overcoming at least some of the above-mentioned challenges. For example, an improved (e.g., new) circuit for providing a reference voltage, which does not (e.g., need to) rely on small transistor sizing sensitive to transistor mismatch. Moreover, the example embodiment(s) of the present disclosure provides the VR circuit with a compact architecture and achieves a pico-watt power consumption.

In an example embodiment, this disclosure is a circuit for providing a reference voltage. The circuit includes a first MOS transistor configured to provide a zero-gate-voltage drain current to a set of transistors connected between the drain of the first MOS transistor and ground. The set of transistors includes a second MOS transistor configured to generate a first PTAT voltage, a BJT configured to generate a CTAT voltage, and a third MOS transistor configured to generate a second PTAT voltage and connecting the set of transistors to ground. The reference voltage is the sum of the first PTAT voltage, the second PTAT voltage, and the CTAT voltage. The first MOS transistor and the third MOS transistor are of the same type of device. A source-bulk voltage of the third MOS transistor is non-zero to increase a threshold voltage of the third MOS transistor. The first PTAT voltage is independent of a threshold voltage of the second MOS transistor. A dependence of the second PTAT voltage on the threshold voltage of the third MOS transistor is the opposite of a dependence of the CTAT voltage on a threshold voltage of the first MOS transistor.

The first PTAT voltage generated by the second MOS transistor may be fabrication-process insensitive. Thereby, a fabrication-process skew may mainly influence the threshold voltages of the MOS transistors. The first PTAT voltage is insensitive to threshold voltage variation.

Instead of relying on small transistor sizing, which is sensitive to transistor mismatch, the voltage reference circuit in the example embodiment introduces the third MOS transistor with bulk biasing (i.e., the source-bulk voltage is non-zero). The consequent body effect induces an extra threshold voltage component, in addition to the threshold voltage that the third transistor would have with zero source-bulk voltage, wherein the threshold voltage would be the same as the threshold voltage of the first MOS transistor, due to the first and the third MOS transistor being of the same type of device. The extra threshold voltage component changes in the same direction with fabrication-process skew as the threshold voltage of the first MOS transistor, which allows fabrication-process induced variations of the reference voltage provided by the circuit of the first example embodiment to be cancelled out. For example, the threshold voltage of the third MOS transistor may vary in (e.g., towards) the same direction with fabrication process skew as the threshold voltage of the first MOS transistor.

In an example embodiment of the circuit, a fabrication-process dependence of the threshold voltage of the first MOS transistor is the same as the threshold voltage of the third MOS transistor.

This allows suppressing fabrication-process induced variations of the reference voltage.

In an example embodiment of the circuit, the circuit further includes a fourth MOS transistor connected between the first MOS transistor and a supply voltage, wherein a gate of the fourth MOS transistor is connected to the reference voltage.

The fourth transistor may be used as a regulating transistor, in order to enhance a line regulation of the reference voltage, i.e., to maintain a constant output reference voltage despite variations in an input supply voltage.

In an example embodiment of the circuit, the second MOS transistor is connected to the first MOS transistor, and the BJT is connected between the second MOS transistor and the third MOS transistor.

In an example embodiment of the circuit, a source of the second MOS transistor is connected to a drain of the first MOS transistor, an emitter of the BJT is connected to a drain of the second MOS transistor, a source of the third MOS transistor is connected to a base of the BJT, and a drain of the third MOS transistor is connected to ground.

The above example embodiment describes a first variation of the circuit of the first example embodiment.

In an example embodiment of the circuit, the BJT is connected to the first MOS transistor, and the second MOS transistor is connected between the BJT and the third MOS transistor.

In an example embodiment of the circuit, an emitter of the BJT is connected to a drain of the first MOS transistor, a source of the second MOS transistor is connected to a base of the BJT, a source of the third MOS transistor is connected to a drain of the second MOS transistor, and a drain of the third MOS transistor (M_{COMP}) is connected to ground.

The above example embodiments describe a second variation of the circuit.

In an example embodiment of the circuit, a collector of the BJT is connected to ground.

In an example embodiment of the circuit, a gate and the drain of the second MOS transistor are connected together, and a gate and the drain of the third MOS transistor are connected together.

In an example embodiment of the circuit, a bulk of the third MOS transistor is connected to a gate of the first MOS transistor.

This provides the non-zero source-bulk voltage of the third MOS transistor and thus provides the body effect.

In an example embodiment of the circuit, a threshold voltage of the third MOS transistor is higher, due to the non-zero source-bulk voltage, than a threshold voltage of the first MOS transistor and as a threshold voltage of the second MOS transistor, respectively.

In an example embodiment of the circuit, the first MOS transistor, the second MOS transistor, and the third MOS transistor are of the same type of device.

“Same type of device” may refer to transistors with (e.g., substantially) identical structures and operational characteristics, such as all nMOS or all pMOS, which are fabricated under the same conditions to exhibit similar behavior and performance, and the same variations of their characteristics induced by fabrication-process skew. For example, the MOS transistors of the same type of device may be matched transistors. Matched transistors are (e.g., substantially) identical devices with similar electrical characteristics, fabricated closely on the same chip to minimize variations and provide (e.g., ensure) consistent performance.

In an example embodiment of the circuit, the first PTAT voltage is a source-gate voltage of the second MOS transistor, and/or the second PTAT voltage is a source-gate voltage of the third MOS transistor.

In an example embodiment of the circuit, the CTAT voltage is an emitter-base voltage of the BJT.

A second example embodiment of this disclosure provides a neural interface. The neural interface includes an electrode area including a plurality of electrodes configured to record and/or stimulate brain activity, one or more thermal sensors configured to measure a temperature of the electrode area, wherein each thermal sensor comprises a circuit according to the first example embodiment or any implementation thereof.

The neural interface of the second example embodiment benefits from the improvements of the reference voltage circuit of the first example embodiment, which have been described above. For example, an improved, e.g. more accurate, temperature measurement of the thermal sensor is possible.

### BRIEF DESCRIPTION OF THE FIGURES

The above described embodiments and implementations are explained in the following description of embodiments with respect to the enclosed drawings:

FIG. 1 shows a circuit according to this disclosure for providing a reference voltage as output.

FIGS. 2A and 2B are two examples of the reference voltage circuit according to an example embodiment of this disclosure.

FIG. 3A shows temperature characteristics at different process corners of a circuit according to this disclosure compared with an example hybrid VR circuit, and FIG. 3B shows process and transistor mismatch Monte-Carlo simulations.

FIG. 4 shows a neural interface according to this disclosure, which includes a reference voltage circuit as in FIG. 1 or 2A or 2B.

FIGS. 5A and 5B show example hybrid VR circuits.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

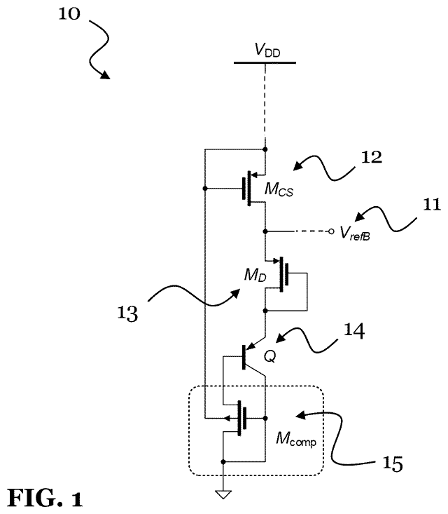

FIG. 1 shows a reference voltage circuit 10 according to this disclosure. The circuit 10 is configured to provide a reference voltage 11 denoted V_{refB}. The circuit 10 may be regarded as a hybrid VR circuit, as it includes a BJT and several MOS transistors. Foe example, the circuit 10 comprises a first MOS transistor 12 denoted M_{CS}, a second MOS transistor 13 denoted M_{D}, a third MOS transistor 15 denoted M_{COMP}, and a BJT 14 denoted Q. The transistors 13, 14 and 15 form a set of transistors. The MOS transistors 12, 13, 15 may respectively be implemented as pMOS or nMOS transistors.

The first MOS transistor 12 may receive a supply voltage denoted V_{DD}, and is configured to provide a zero-gate-voltage drain current to the set of transistors 13, 14, 15. The set of transistors 13, 14, 15 is connected between the drain of the first MOS transistor 12 and ground. In FIG. 1, as an example, the second MOS transistor 13 is connected to the first MOS transistor 12, the third MOS transistor 15 is connected to ground, and the BJT 14 is connected between the second MOS transistor 13 and the third MOS transistor 15. However, as shown and described later, the arrangement of the transistors of the set of transistors 13, 14, 15 may also be different than in FIG. 1.

The second MOS transistor 13 is configured to generate a first PTAT voltage, wherein the first PTAT voltage is independent of a threshold voltage of the second MOS transistor 13, and is thus independent from a fabrication-process skew of a fabrication process used to produce the MOS transistor(s). The BJT 14 may, for example, be a vertical (e.g. PNP) BJT in CMOS technology. The BJT 14 is configured to generate a CTAT voltage, and the third MOS transistor 15 is configured to generate a second PTAT voltage. The reference voltage 11 is the sum of the first PTAT voltage, the second PTAT voltage, and the CTAT voltage. That is, the combination of the PTAT and CTAT voltages is made in a stacked manner.

The first MOS transistor 12 and the third MOS transistor 15 are of the same type of device, e.g., are matched transistors. MOS transistors of the same type of device (e.g., all n-channel or all p-channel) are fabricated using the same materials and processes, leading to similar electrical characteristics and process variations. This provides they experience a comparable fabrication-process skew, meaning that variations in their performance caused by manufacturing deviations are consistent across the MOS transistors. The MOS transistors 12, 13, and 15 may respectively be low-threshold voltage MOS transistors.

A source-bulk voltage of the third MOS transistor 15 is non-zero, so as to increase the threshold voltage of the third MOS transistor 15. A non-zero source-bulk voltage in a MOS transistor creates a body effect, which alters the MOS transistor's threshold voltage. This occurs because the non-zero source-bulk voltage modifies the depletion region, thereby affecting carrier inversion and the overall device behavior.

A dependence of the second PTAT voltage on the threshold voltage of the third MOS transistor 15 is, in the circuit 10, the opposite of a dependence of the CTAT voltage on a threshold voltage of the first MOS transistor 12. For example, a threshold voltage of the first MOS transistor 12 may change in the same direction with fabrication-process skew than the increased threshold voltage of the third transistor 15. This is beneficially used in the circuit 10 to cancel out fabrication-process variations of the reference voltage 11.

For example, in a “fast corner” of the fabrication process, the threshold voltages become less than in the (e.g., typical) fabrication process corners, which increases the current flowing into the emitter of the BJT, which again raises the CTAT voltage. However, with the third transistor 15 being bulk-biased, the reference voltage 11 may still be maintained close to the value, which it has in the (e.g., typical) fabrication process corner.

Process corners represent variations in the fabrication process, which may affect transistor performance, and are usually categorized as “fast,” “slow,” or “typical.” These fabrication process corners reflect differences in parameters like threshold voltage, channel resistance, and mobility, impacting speed, power, and reliability. A fast process corner refers to a variation in fabrication where transistors exhibit higher-than-nominal performance, due to reduced channel resistance or increased carrier mobility. This may lead to faster switching speeds, lower threshold voltages, and potentially higher power consumption compared to typical or slow fabrication process corners.

The circuit 10 of FIG. 1 may provide a compact architecture and (e.g., only) pico-watt power consumption. The circuit 10 may be based on the same principles as a BGR circuit and may be as reliable. Additionally, internal threshold voltage variations do not affect the output reference voltage 11, or at least (e.g., only) insignificantly impact the output reference voltage 11.

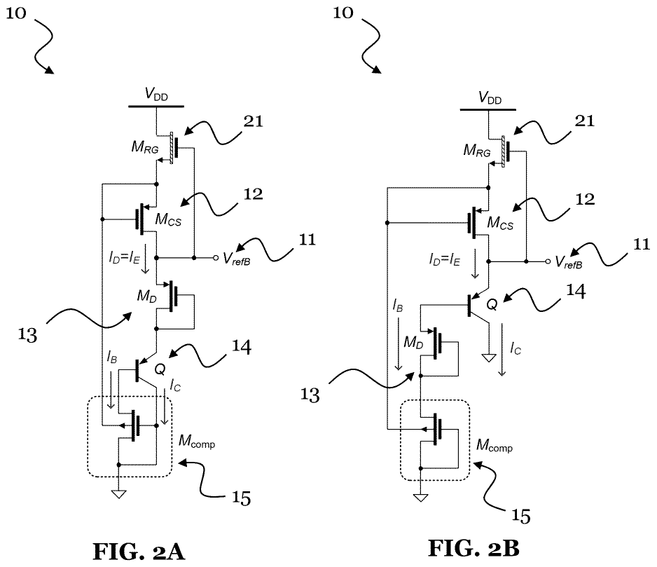

FIG. 2A is a first example of the reference voltage circuit 10 according to an example embodiment of this disclosure, which is based on the circuit 10 shown in FIG. 1. Same elements are labelled with the same reference signs and may be implemented likewise.

The circuit 10 of FIG. 2A has the same “order” of transistors in the set of transistors 13, 14, 15, which is between the first MOS transistor 12 and ground. For example, the second MOS transistor 13 is connected to the first MOS transistor 12, and the BJT 14 is connected between the second MOS transistor 13 and the third MOS transistor 15. As shown in the example, the source of the second MOS transistor 13 is connected to the drain of the first MOS transistor 12, the emitter of the BJT 14 is connected to the drain of the second MOS transistor 13, the source of the third MOS transistor 15 is connected to the base of the BJT 14, and the drain of the third MOS transistor 15 is connected to ground. The collector of the BJT 14 is further connected to ground. The gate and the drain of the second MOS transistor 13 are connected together, and the gate and the drain of the third MOS transistor 15 are connected together. The bulk of the third MOS transistor 15 is connected to the gate of the first MOS transistor 12.

The circuit 10 of FIG. 2A further comprises a fourth MOS transistor 21 denoted M_{RG}, which is connected between the first MOS transistor 12 and a supply voltage V_{DD}. The gate of the fourth MOS transistor 21 is connected to the reference voltage 11. The fourth MOS transistor 21 may be used as a regulating transistor to enhance a line regulation of the reference voltage 11.

The BJT 14 operates as a CTAT voltage (V_{EB}=V_{CTAT}) generator. That is, the CTAT voltage V_{CTAT} may be the emitter-base voltage V_{EB} of the BJT 14. The first MOS transistor 12, having its gate and source connected, is configured to act as a bias current generator. It produces a zero-gate-voltage drain current I_{D} that is a function of the threshold voltage V_{TH_CS} of the first MOS transistor 12, and that flows through the second MOS transistor 13 and the BJT 14 before reaching ground. With this current I_{D}, the second MOS transistor 13 generates a process-insensitive PTAT voltage (V_{SG_MD}=V_{PTAT}). The first PTAT voltage V_{PTAT} is a source-gate voltage V_{SG_MD} of the second MOS transistor 13.

The BJT 14 may have a current gain less than three, so that a (e.g., significant) portion of the emitter current I_{E}=I_{D} flows to the base terminal of the BJT 14, and passes the third MOS transistor 15 to ground. The CTAT voltage becomes fabrication-process-sensitive, since the emitter current I_{E}=I_{D} is sensitive to the threshold voltage V_{TH_CS} of the first MOS transistor 12, and varies across different fabrication process corners. This fabrication-process induced variations would fully relay to the reference voltage 11, if the base terminal of the BJT 14 would be grounded.

However, to cancel out such a process variations in the circuit 10, the third MOS transistor 15 is arranged between the base terminal of the BJT 14 and the ground. The third MOS transistor 15 is configured to generate a process-insensitive second PTAT voltage, as the main part of the reference voltage 11, and an extra threshold voltage V_{TH}_{_{BS}}coming from the bulk effect (the bulk terminal of the third MOS transistor 15 is connected to the source terminal of the fourth MOS transistor instead of the third MOS transistor 15 itself).

Since the same type of device is utilized for the first, the second, and the third MOS transistor (i.e., for M_{CS}, M_{D}, and M_{comp}), the additional threshold voltage V_{TH}_{_{BS}} will skew towards the same direction as the threshold voltage V_{TH}_{_{CS}} . That is, the third MOS transistor 15 has a larger threshold voltage (due to the body effect) than that of the first MOS transistor 12 and the second MOS transistor 13, respectively, but the process skew is still the same. This may cancel out the process variation of the reference voltage 11 considerably.

Considering the example circuit 10 in FIG. 2A, the output reference voltage 11 may be derived as

$${V}_{refB} = {V}_{S {G}_{M comp}} + {V}_{EB} + {V}_{S {G}_{M D}}$$

The reference voltage 11 is the sum of the first PTAT voltage (which is the source-gate voltage V_{SG}_{_{MD}}of the second MOS transistor 13 in this example), the CTAT voltage (which is the emitter-based voltage V_{EB}of the BJT 14 in this example), and the second PTAT voltage (which is the source-gate voltage V_{SG}_{_{Mcomp}} of the third MOS transistor 15 in this example). V_{SG_MD} is a process-insensitive PTAT voltage, so that (e.g., only) the terms V_{SG}_{_{Mcomp}} and V_{EB} in the reference voltage 11 are varied with fabrication process corners, however, in opposite directions.

In the fast process corner, V_{TH}_{_{CS}} (and also V_{TH}_{_{BS}}) may become less than they are in (e.g., typical) process corners, making I_{D} and I_{E} higher. The higher emitter current I_{E} will raise the CTAT voltage V_{CTAT} (it is the emitter-based voltage V_{EB} of the BJT 14). Without having the third transistor 15, or if connecting the base terminal of the BJT 14 directly to ground, the reference voltage V_{refB} would increase with such a process variation. The difference in reference voltage 11 could be up to 25 mV in 55 nm CMOS technology. However, by having the third MOS transistor 15, when V_{CTAT} is increased, the second PTAT voltage which is the source-gate voltage V_{SG_Mcomp} of the third MOS transistor 15 here, will decrease, since the threshold voltage of the third MOS transistor 15 gets smaller. Due to the third MOS transistor 15, the reference voltage 11 may thus be maintained close to the same value it has in the (e.g., typical) fabrication process corner. In the slow process corner, the circuit 10 of FIG. 2A operates vice versa, and the reference voltage 11 may also be maintained close to the same value it has in the (e.g., typical) process corner.

FIG. 2B shows a second example of the reference voltage circuit 10 according to this disclosure, which is based on the circuit 10 shown in FIG. 1. Same elements are labeled with the same reference signs and may be implemented likewise. In FIG. 2B, compared to FIG. 2A, the location of the second MOS transistor 13 is changed. That is, the order of transistors in the set of transistors 13, 14, 15 is different than in FIG. 2A. For example, the BJT 14 is connected to the first MOS transistor 12, and the second MOS transistor 13 is connected between the BJT 14 and the third MOS transistor 15.

In this example, the emitter of the BJT 14 is connected to the drain of the first MOS transistor 12, the source of the second MOS transistors 13 is connected to the base of the BJT 14, the source of the third MOS transistor 15 is connected to the drain of the second MOS transistor 13, and the drain of the third MOS transistor 15 is connected to ground. The collector of the BJT 14 is further connected to ground. The gate and the drain of the second MOS transistor 13 are connected together, and the gate and the drain of the third MOS transistor 15 are connected together. The bulk of the third MOS transistor 15 is connected to the gate of the first MOS transistor 12.

As in FIG. 2A and also in FIG. 2B, the third MOS transistor 15 is at the lowest, i.e., is the transistor closest to ground. In both examples, the third MOS transistor 15 is arranged to connect the set of transistors 13, 14, 15 to ground.

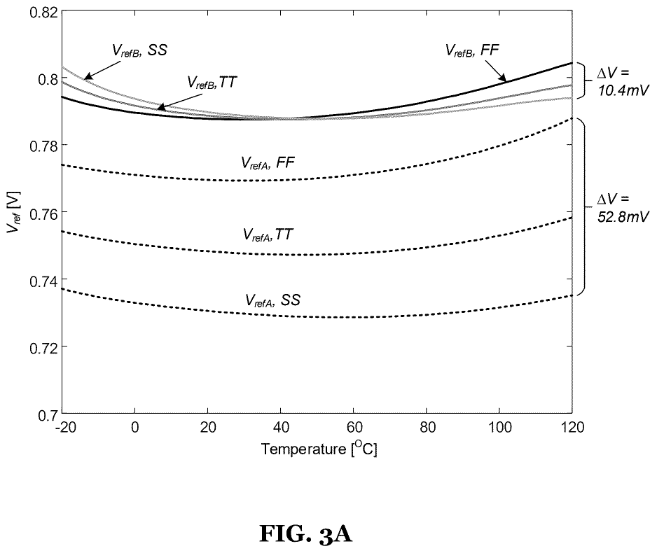

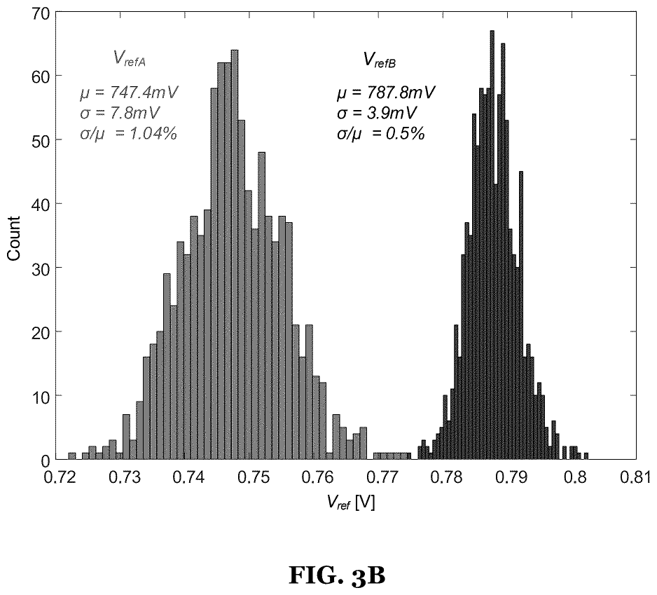

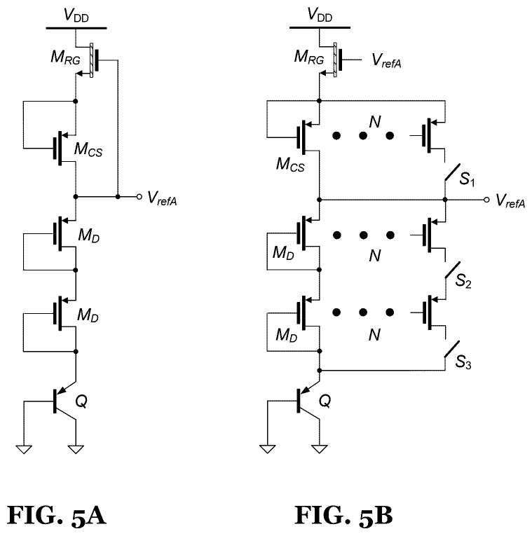

FIG. 3A shows temperature characteristics of the hybrid VR circuit shown in FIG. 5A without sizing for process compensation in comparison with the circuit 10 shown in FIG. 2A. Both circuits 10 were simulated in 55 nm technology from temperatures of −20° C. to 120° C. The difference of the reference voltage V_{refA} output by the hybrid VR of FIG. 5A between slow and fast process corners is as high as 52.8 mV at 120° C. With the compensation mechanism of the reference voltage circuit 10 of FIG. 2A, the corresponding difference of the reference voltage V_{refB} between slow and fast process corners is (e.g., only) 10.4 mV at the same temperature. This confirms that the process variation suppression of the circuit 10 is effective.

FIG. 3B also demonstrates a 500-run statistical Monte-Carlo simulation involving both process variation and transistor mismatch. It shows that the reference voltage V_{refA} output by the hybrid VR circuit of FIG. 5A attends a coefficient of variability (σ/μ) of 1.04%, whereas for the circuit 10 with process cancellation shown in FIG. 2A, the variability of the output reference voltage V_{refB} is reduced to 0.5%.

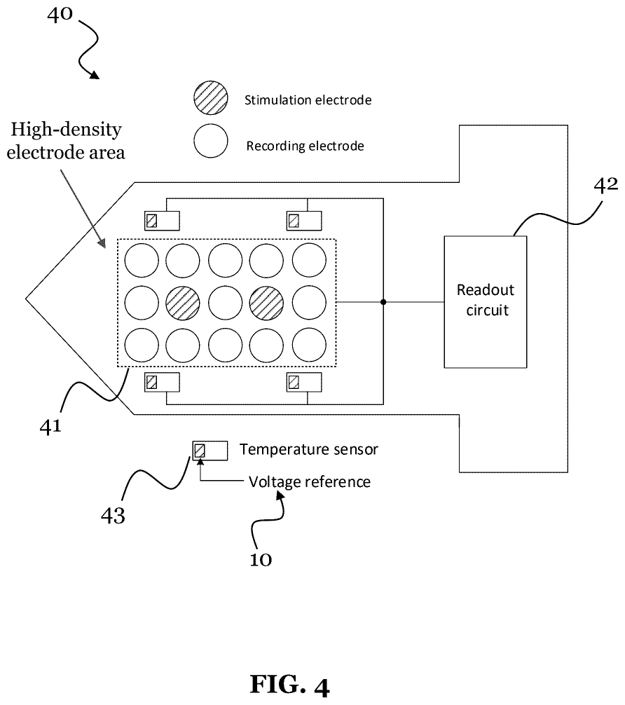

FIG. 4 shows an exemplary application scenario of the reference voltage circuit 10 of this disclosure. For example, FIG. 4 shows a neural interface 40, as it may be used in medical research, e.g., for studying brain activity. The neural interface 40 may be used as a bi-directional neural probe.

The neural interface 40 comprises an electrode area 41, which includes a plurality of electrodes configured to record and/or stimulate brain activity, i.e., includes both recording electrodes and stimulation electrodes, although the arrangement is (e.g., only) an example.

Having the stimulation electrodes may heat up the area nearby the electrodes. Therefore, the neural interface 40 comprises one or more thermal sensors 43, which are respectively configured to measure a temperature of the electrode area 41. For example, multiple compact thermal sensors may be distributed close to this area 41, in order to monitor the temperature variations.

At least one or each thermal sensor 43 may comprise a reference voltage circuit 10 according to the present disclosure, for example, as described and shown in FIGS. 1 and 2. The voltage reference circuit 10 may be a part of the respective thermal sensor 43. Thus, the sensor 43 may be small (e.g., tiny) and (e.g., extremely low-power), such as <1 nW, which may be achieved with the circuit 10 of the present disclosure.

In summary, the reference voltage circuit 10 of this disclosure offers an improvement to achieve low process and mismatch variations, a power consumption below 1 nW at room temperature, and a small (e.g., very tiny) area. The present disclosure may be applicable to implantable neural devices and IoT sensor nodes.

In the present disclosure, the word “comprising” does not exclude other elements or steps and the indefinite article “a” or “an” does not exclude a plurality. A single element may fulfill the functions of several entities or items recited in the claims. The mere fact that certain measures are recited in the mutual different dependent claims does not indicate that a combination of these measures may not be used in an improved implementation.

While some embodiments have been illustrated and described in detail in the appended drawings and the foregoing description, such illustration and description are to be considered illustrative and not restrictive. Other variations to the disclosed embodiments may be understood and effected in practicing the claims, from a study of the drawings, the disclosure, and the appended claims. The mere fact that certain measures or features are recited in mutually different dependent claims does not indicate that a combination of these measures or features cannot be used. Any reference signs in the claims should not be construed as limiting the scope.

What is claimed is:

1. A circuit for providing a reference voltage, the circuit comprising:
a first MOS transistor configured to provide a zero-gate-voltage drain current to a set of transistors connected between the drain of the first MOS transistor and ground;
wherein the set of transistors comprises:
a second MOS transistor, configured to generate a first proportional to absolute temperature (PTAT) voltage;
a bipolar junction transistor (BJT) configured to generate a complementary to absolute temperature (CTAT) voltage; and
a third MOS transistor configured to generate a second PTAT voltage and connecting the set of transistors to ground;
wherein the reference voltage is a sum of the first PTAT voltage, the second PTAT voltage, and the CTAT voltage;
wherein the first MOS transistor and the third MOS transistor are of the same type of transistor;
wherein a source-bulk voltage of the third MOS transistor is non-zero to increase a threshold voltage of the third MOS transistor;
wherein the first PTAT voltage is independent of a threshold voltage of the second MOS transistor; and
wherein a dependence of the second PTAT voltage on the threshold voltage of the third MOS transistor is opposite of a dependence of the CTAT voltage on a threshold voltage of the first MOS transistor.

2. The circuit according to claim 1, wherein a fabrication-process dependence of the threshold voltage of the first MOS transistor is the same as the threshold voltage of the third MOS transistor.

3. The circuit according to claim 1, further comprising a fourth MOS transistor connected between the first MOS transistor and a supply voltage, wherein a gate of the fourth MOS transistor is connected to the reference voltage.

4. The circuit according to claim 1, wherein the second MOS transistor is connected to the first MOS transistor, and the BJT is connected between the second MOS transistor and the third MOS transistor.

5. The circuit according to claim 4, wherein
a source of the second MOS transistor is connected to a drain of the first MOS transistor;
an emitter of the BJT is connected to a drain of the second MOS transistor;
a source of the third MOS transistor is connected to a base of the BJT; and
a drain of the third MOS transistor is connected to ground.

6. The circuit according to claim 1, wherein the BJT is connected to the first MOS transistor, and the second MOS transistor is connected between the BJT and the third MOS transistor.

7. The circuit according to claim 6, wherein
an emitter of the BJT is connected to a drain of the first MOS transistor;
a source of the second MOS transistor is connected to a base of the BJT;
a source of the third MOS transistor is connected to a drain of the second MOS transistor; and
a drain of the third MOS transistor is connected to ground.

8. The circuit according to claim 3, wherein a collector of the BJT is connected to ground.

9. The circuit according claim 7, wherein a gate and the drain of the second MOS transistor are connected; and
a gate and the drain of the third MOS transistor are connected.

10. The circuit according to claim 1, wherein a bulk of the third MOS transistor is connected to a gate of the first MOS transistor.

11. The circuit according to claim 1, wherein
a threshold voltage of the third MOS transistor is higher, due to the non-zero source-bulk voltage, than a threshold voltage of the first MOS transistor; and
the threshold voltage of the third MOS transistor is higher than a threshold voltage of the second MOS transistor.

12. The circuit according to claim 1, wherein the first MOS transistor, the second MOS transistor, and the third MOS transistor are the same type of transistor.

13. The circuit according to claim 1, wherein
the first PTAT voltage is a source-gate voltage of the second MOS transistor; or
the second PTAT voltage is a source-gate voltage of the third MOS transistor.

14. The circuit according to claim 1, wherein the CTAT voltage is an emitter-base voltage of the BJT.

15. A neural interface comprising:
an electrode area including a plurality of electrodes configured to record or stimulate brain activity; and
at least one thermal sensor configured to measure a temperature of the electrode area, wherein the at least one thermal sensor comprises a circuit including:
a first MOS transistor configured to provide a zero-gate-voltage drain current to a set of transistors connected between the drain of the first MOS transistor and ground;
wherein the set of transistors comprises:
a second MOS transistor, configured to generate a first proportional to absolute temperature (PTAT) voltage;
a bipolar junction transistor (BJT) configured to generate a complementary to absolute temperature (CTAT) voltage; and
a third MOS transistor configured to generate a second PTAT voltage and connecting the set of transistors to ground;
wherein the reference voltage is a sum of the first PTAT voltage, the second PTAT voltage, and the CTAT voltage;
wherein the first MOS transistor and the third MOS transistor are of the same type of transistor;
wherein a source-bulk voltage of the third MOS transistor is non-zero to increase a threshold voltage of the third MOS transistor;
wherein the first PTAT voltage is independent of a threshold voltage of the second MOS transistor; and
wherein a dependence of the second PTAT voltage on the threshold voltage of the third MOS transistor is opposite of a dependence of the CTAT voltage on a threshold voltage of the first MOS transistor.

16. The neural interface according to claim 15, wherein a fabrication-process dependence of the threshold voltage of the first MOS transistor is the same as the threshold voltage of the third MOS transistor.

17. The neural interface according to claim 15, further comprising a fourth MOS transistor connected between the first MOS transistor and a supply voltage, wherein a gate of the fourth MOS transistor is connected to the reference voltage.

18. The neural interface according to claim 15, wherein the second MOS transistor is connected to the first MOS transistor, and the BJT is connected between the second MOS transistor and the third MOS transistor.

19. The neural interface according to claim 18, wherein
a source of the second MOS transistor is connected to a drain of the first MOS transistor;
an emitter of the BJT is connected to a drain of the second MOS transistor;
a source of the third MOS transistor is connected to a base of the BJT; and
a drain of the third MOS transistor is connected to ground.

20. The neural interface according to claim 15, wherein the first MOS transistor, the second MOS transistor, and the third MOS transistor are the same type of transistor.
